(19) United States
(12) Patent Application Publication
(10) Pub. No.: US 2013/0105404 A1
(43) Pub. Date: May 2, 2013

(54) OIL FILTRATION SYSTEM FOR A LOAD TAP CHANGER

(71) Applicant: WAUKESHA ELECTRIC SYSTEMS, INC., Waukesha, WI (US)

(72) Inventors: Arthur MARTIN, Rowlett, TX (US); John PRUENTE, Keller, TX (US)

(73) Assignee: WAUKESHA ELECTRIC SYSTEMS, INC., Waukesha, WI (US)

(21) Appl. No.: 13/664,560

(22) Filed: Oct. 31, 2012

Related U.S. Application Data
(60) Provisional application No. 61/552,758, filed on Oct. 28, 2011.

(51) Int. Cl. B01D 35/04

(52) U.S. Cl. 210/741; 210/149; 210/103; 210/138; 210/87

(57) ABSTRACT

An oil filtration system for a load tap changer includes a filter configured to filter oil, a pump fluidly coupled to an oil tank and configured to pump the oil from the oil tank through the filter and to return the oil to the oil tank, and a control system, electrically coupled to the pump. The control system monitors ambient air temperature and controls an operation of the pump in accordance therewith. Additionally or alternatively, the control system monitors at least one of a high-pressure sensor, a flow sensor, a leak sensor, and a low flow sensor and controls an operation of the pump in accordance therewith.

### CROSS-REFERENCE TO RELATED APPLICATIONS

This application claims the benefit of U.S. Provisional Application No. 61/552,758 filed on Oct. 28, 2011, which is hereby incorporated by reference in its entirety for all purposes as if fully set forth herein.

### FIELD OF THE INVENTION

The invention relates to an oil filtration system. More particularly, to a load tap changer (LTC) oil filtration system designed to remove operating contaminants from insulating oil of the LTC in order to maintain the insulating oil at the highest possible dielectric strength and minimize equipment failure and downtime.

### BACKGROUND OF THE INVENTION

A load tap changer (LTC) oil filtration system was developed to meet the electric utility industry's need to reduce the overall operational and maintenance costs of LTCs without sacrificing system reliability. Oftentimes, the LTC oil filtration system installed in the field may not operate properly under extreme conditions, such as cold conditions. In particular, starting the oil filtration system when the temperature of the insulating oil of the LTC is significantly below freezing may lead to various problems. For example, the pump motor of the oil filtration system may stall which may result in a damaged motor or other system damage. Even when the oil filtration system starts, the density of the insulating oil in the oil filtration system may produce a high pressure or low flow shutting down and/or damaging the oil filtration system. Either of the problems would result in a service technician needing to be dispatched to the field to attempt to repair the oil filtration system.

Thus, there is a need for improving oil filtration systems operating in extreme conditions such as cold conditions.

### SUMMARY OF THE INVENTION

The foregoing needs are met, to a great extent, by the invention, wherein in one aspect a technique and apparatus are provided for providing and improved oil filtration system that may operate under extreme conditions.

In accordance with one embodiment, an oil filtration system for a load tap changer includes a filter configured to filter an oil, a pump fluidly coupled to an oil tank and configured to pump the oil from the oil tank through the filter and to return the oil to the oil tank, and a control system, electrically coupled to the pump, to monitor ambient air temperature and control an operation of the pump in accordance therewith.

In accordance with one embodiment, an oil filtration system for a load tap changer includes a filter configured to filter an oil, a pump fluidly coupled to an oil tank and configured to pump the oil from the oil tank through the filter and to return the oil to the oil tank, at least one of a high-pressure sensor, a flow sensor, a leak sensor, and a low flow sensor, and a control system, electrically coupled to the pump, to monitor at least one of the high-pressure sensor, the flow sensor, the leak sensor, and the low flow sensor and control an operation of the pump in accordance therewith.

In accordance with one embodiment, an oil filtration process for a load tap changer includes arranging a filter to filter oil, pumping oil from an oil tank through the filter and returning the oil to the oil tank, sensing at least one of a high-pressure, a flow, a leak, and low flow, and controlling the pumping in response to sensing at least one of the high-pressure, the flow, the leak, and the low flow.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1, including FIG. 1A and FIG. 1B, illustrates a load tap changer (LTC) oil filtration system constructed according to an aspect of the invention.

FIG. 2 illustrates the LTC oil filtration system of FIG. 1 connected to an LTC oil tank constructed according to an aspect of the invention.

FIG. 3 illustrates a flexible tube installation kit in accordance with a particular embodiment of the invention.

FIG. 4 illustrates a circuit diagram of the control system of the oil filtration system in accordance with a particular embodiment of the invention.

FIG. 5 illustrates a control box with bypass switch and motor runtime meter in accordance with a particular embodiment.

FIG. 6 illustrates various components of the control box in accordance with a particular embodiment of the invention.

### DETAILED DESCRIPTION

The invention will now be described with reference to the drawing figures, in which like reference numerals refer to like parts throughout. Embodiments of the invention advantageously provide an oil filtration system that may better operate in cold conditions.

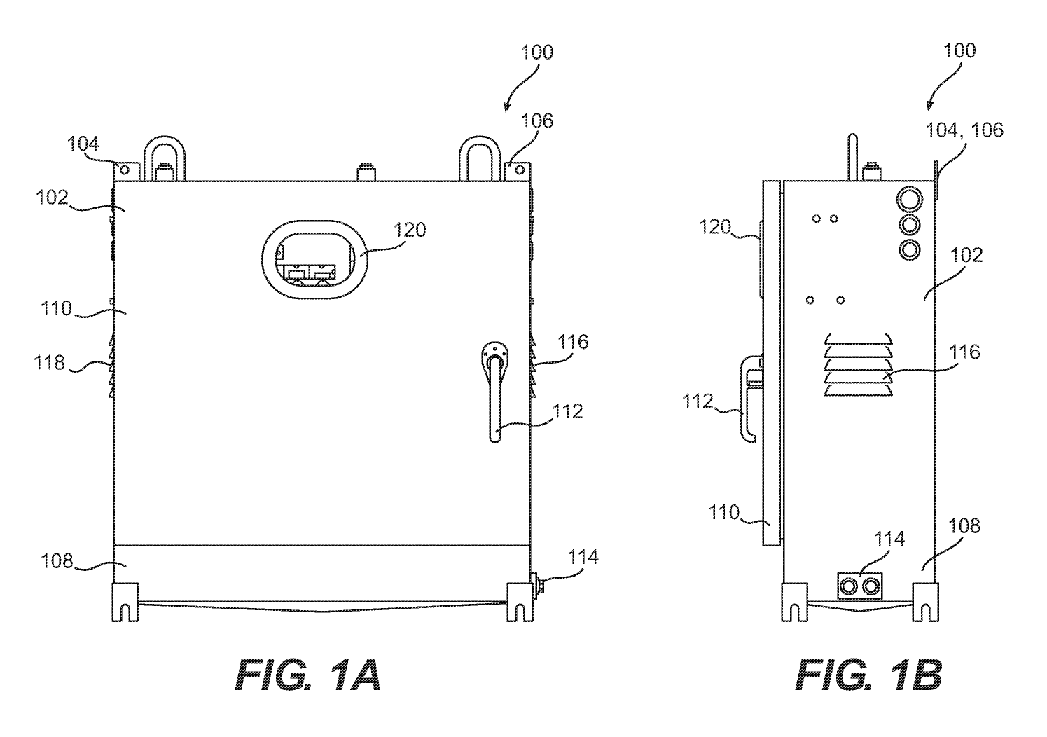

FIG. 1, including FIG. 1A and FIG. 1B, illustrates a load tap changer (LTC) oil filtration system. In particular, FIG. 1 illustrates a LTC oil filtration system 100 that may include a weather proof cabinet 102 having integral mounting flanges 104, 106 and anti-condensate heating. The oil filtration system 100 may include a cabinet sump 108 to ensure the avoidance of any environmental spills.

The oil filtration system 100 may further include an access door 110 and a locking handle 112. The oil filtration system 100 may include a ground pad 114 in order to provide a grounded connection to the oil filtration system 100. The oil filtration system 100 may further include vents 116, 118 on one or more sides of the cabinet 102 to allow air flow through the cabinet 102. Finally, the oil filtration system 100 may include an access window 120 in order for maintenance personnel to view internal components of the oil filtration system 100 including status lights.

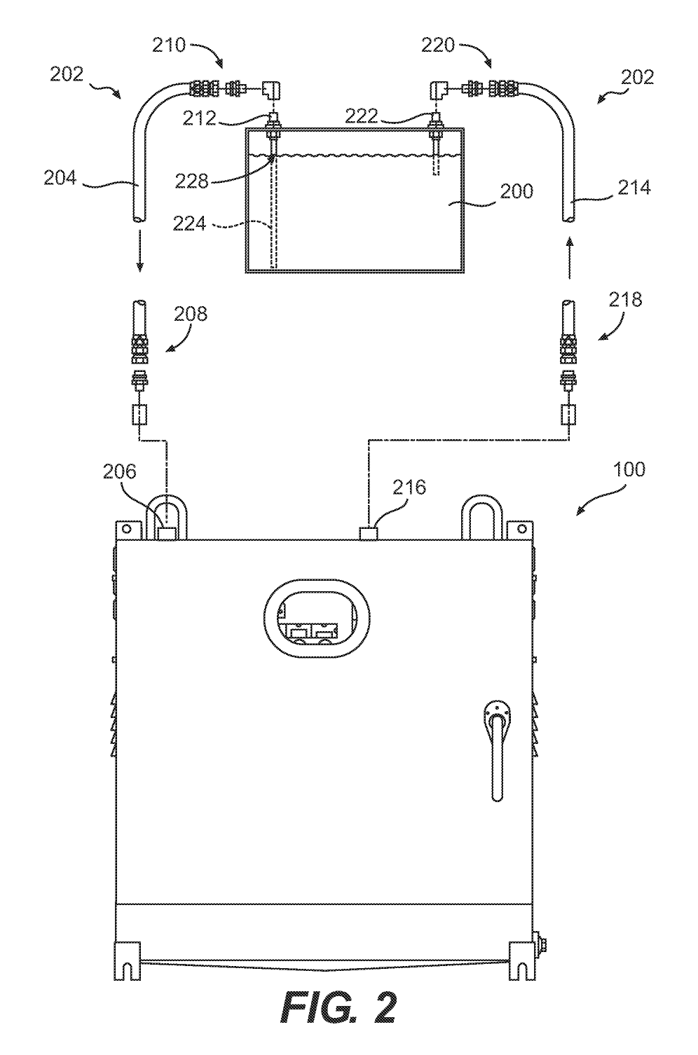

FIG. 2 illustrates the LTC oil filtration system connected to an LTC oil tank. In particular, the oil filtration system 100 may be connected to a LTC oil tank 200 via a flexible tube installation kit 202. Alternatively, the oil filtration system 100 may be connected to the LTC oil tank 200 via a hard pipe or the like (not shown). The flexible tube installation kit 202 may include an oil supply tube 204 that supplies oil from the LTC oil tank 200 to the oil filtration system 100. In particular, the oil supply tube 204 may connect to an oil input 206 on the oil filtration system 100. In this regard, the oil supply tube 204 may include a connector 208 to connect to the oil input 206 on the oil filtration system 100. Likewise, the oil supply tube 204 may include a connector 210 to connect to an output 212 on the LTC oil tank 200. The connectors 208, 210 may be threaded or the like.

The flexible tube installation kit 202 may further include an oil return tube 214 that returns oil to the LTC oil tank 200 from the oil filtration system 100. In particular, the oil return tube 214 may connect to an oil output 216 on the oil filtration system 100. In this regard, the oil return tube 214 may include a connector 218 to connect to an oil output 216 on the oil filtration system 100. Likewise, the oil return tube 214 may include a connector 220 to connect to an input 222 on the LTC oil tank 200. The connectors 218, 220 may be threaded or the like.

The output 212 on the LTC oil tank 200 may include a siphon 224 that extends into the oil tank 200. The siphon 224 siphons the oil in the LTC oil tank 200 and allows it to flow out the output 212. The siphon 224 may include an anti-siphon hole 228 located a predetermined distance below the minimum oil level. Accordingly, when the oil level drops below this predetermined distance, the siphon 224 may no longer be able to siphon oil from the LTC oil tank 200.

In operation, the oil filtration system may siphon oil from the LTC oil tank 200 through the siphon 224 as long as the oil level is above the anti-siphon hole 228. The oil may travel through the oil supply tube 204 and into the oil filtration system 100. Within the oil filtration system 100, the oil may be filtered and the like. Thereafter, the oil may be delivered through the oil return tube 214 back into the LTC oil tank 200.

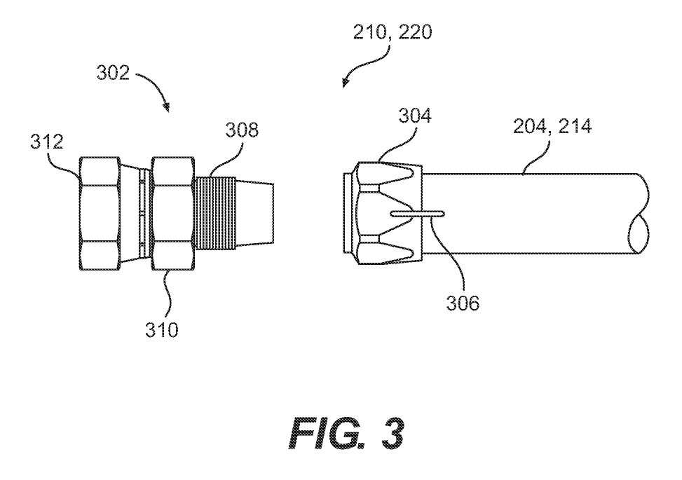

FIG. 3 illustrates a flexible tube installation kit in accordance with a particular embodiment. In particular, FIG. 3 illustrates an exemplary flexible tube installation kit. Numerous other tubes, conduits, or connection systems are contemplated by the invention and are within the spirit and scope thereof. The tube 204, 214 may be marked and cut to desired length using a fine tooth hacksaw, cutoff machine, or the like. A nipple 302 may be removed from a socket 304. Thereafter, the socket 304 may be placed in vice or the like and screwed in the tube 204, 214 counter-clockwise until the tube 204, 214 buttons out and then may be screwed out half a turn. The tube 204, 214 may be marked with grease pencil or equivalent as shown by grease mark 306 for alignment purposes. The inside of the tube 204, 214 and nipple threads 308 may be oiled liberally with transformer oil before assembly. The nipple 302 may be screwed into the socket 304 using a wrench on a nipple hex 310 until the nipple hex 310 shoulders against the socket 304. Thereafter, the tube 204, 214 may be connected with a female threaded hex 312.

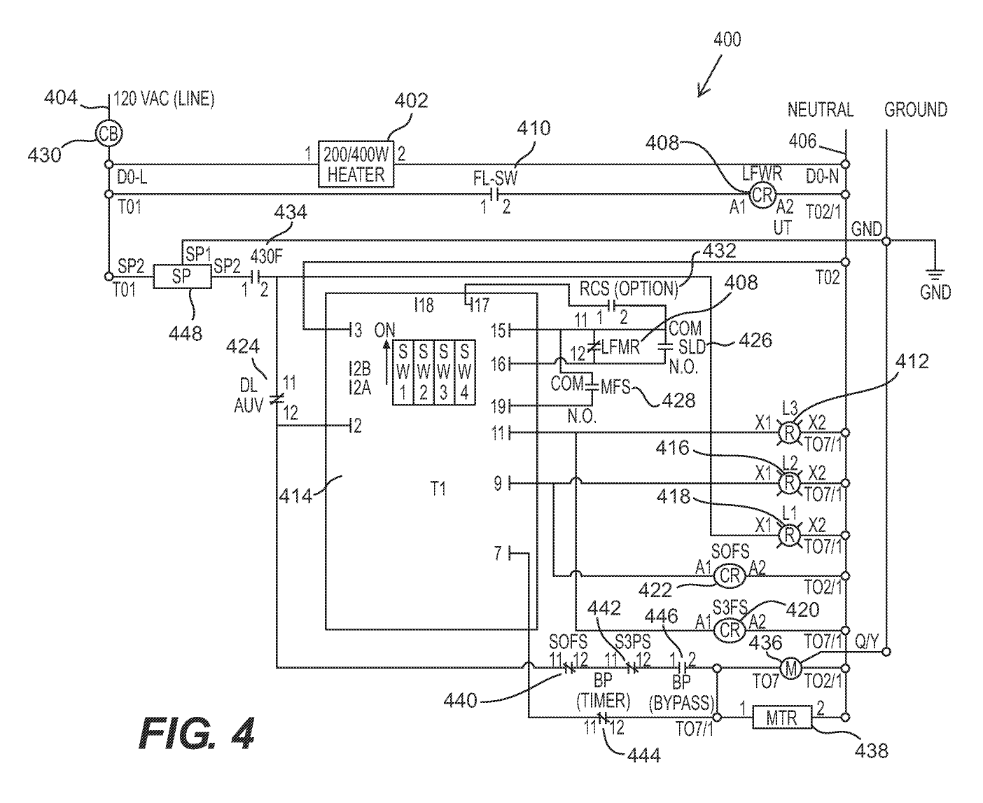

FIG. 4 illustrates a circuit diagram of the control system in accordance with a particular embodiment of the invention. The oil filtration system 100 may also include a control system 400 that monitors various system operation parameters. The control system 400 may include electrical surge protection as described below. The control system 400 monitors oil pressure and provides automatic system shut-down if the oil pressure exceeds a predetermined threshold. In an exemplary embodiment, the control system 400 automatically shuts down the oil filtration system if the oil pressure exceeds a predetermined threshold, such as, for example, 85 PSI. The control system 400 may also include a delay (e.g., 5 minutes) prior to oil filtration system activation to prevent false oil pressure determinations. The control system 400 may also monitor oil pressure to determine whether a filter of the oil filtration system 100 needs maintenance, such as, for example, when the oil pressure exceeds 68 PSI.

As shown in FIG. 4, the control system 400 may include a timer/alarm module 414. The control system 400 may further include a heater 402 connected between a power line 404 and a neutral line 406. The heater 402 may provide heat to provide anti-condensation control of various components within the cabinet 102 and/or the control system 400. Additionally, the control system 400 may control actuation of the pump motor 436.

The power line 404 and the neutral line 406 may also provide power to the timer/alarm module 414. The power line 404 may also connect through an electrical surge protector 448 that provides surge protection for the timer/alarm module 414 and the various components of the control system 400.

The control system 400 may further include a low flow signal mirror relay 408 connected to a low flow sensor 410. The low flow sensor 410 providing an indication when oil flow is low.

The control system 400 may further include a series of outputs indicating various statuses of the control system 400. In particular, the timer/alarm module 414 may output a high-pressure alarm through a high-pressure alarm LED indicator 412; may output a low flow and/or leak detection alarm using a low flow and/or leak detection alarm LED 416; and may indicate power on through a power on LED 418.

A high-pressure alarm relay 420 may include a high-pressure detection sensor 428 that provides an output indicating a high-pressure. The signal is placed on line 11 and also powers the high-pressure alarm LED indicator 412. Additionally, the control system 400 may include a high-pressure/sump leak detection relay 442 to control power going to the pump motor 436.

A Low flow detection alarm relay 422 includes a low flow sensor 410 that provides an output indicating low flow detection. The low flow detection signals are placed on line 9 which also powers the low flow leak detection alarm LED 416. Additionally, the control system 400 may include a low flow detection relay 440 to control power going to the pump motor 436.

The control system 400 may further include a customer remote shutdown relay 424. The customer remote shutdown relay 424 may be input to line 2 and allow for the customer to shut down the control system 400 if desired.

The control system 400 may further include a circuit breaker 430 to protect the various system components from drawing too much current. Additionally, the control system 400 may include a system power switch 434. Moreover, a bypass 446 may be used to bypass certain operations of the control system 400. Finally, a system run cold sensor 432 may be utilized to indicate cold conditions and allow the control system 400 to operate in accordance with cold conditions.

The control system 400 may further include a pump on hour meter 438 to track the time in which the pump motor 436 is actuated. Additionally, a bypass timer relay 444 may be associated with the pump on hour meter 438 to control power to the same.

The control system 400 monitors oil flow rate and provides automatic shutdown if the flow rate is below a predetermined threshold. For example, the control system 400 may automatically shut-down the oil filtration system 100 if the oil flow rate is below 0.25 GPM. Other flow rates are contemplated as well. Again, the control system 400 may include a delay (e.g., 12 seconds) prior to oil filtration system 100 activation in order to prevent false oil flow rate determinations. The control system 400 may also monitor oil flow rate, as noted above, to determine whether filter of the oil filtration system needs maintenance (e.g., clogged Y-strainer). The control system 400 may locate the sensors 426 in the weather proof cabinet 102 that monitor system leaks and provide automatic shut-down if a leak is detected.

The oil filtration system 100 may include a pump system having oil recirculation to prevent oil filtration system over-pressure conditions. The pump system may include hoses having 3000 PSI burst strength stainless steel braid covered hoses in order to provide leak-free service. Other types of hoses are contemplated as well. The pump system may also include a mechanical seal design in order to provide maximum life. The pump motor 436 (e.g., ½ HP) may include automatic reset thermal protection for continuous operation.

The oil filtration system 100 may also include filter cartridges. The filter cartridges may accept high capacity depth filter system with SAE J1858 test score of β5=500 for 5 μm particle size and a score of β3=150 for 3 μm particle size. The filter cartridges may also accept 0.3 micron pleated filter element.

The oil filtration system 100 may include various elements to ease maintenance. For example, the oil filtration system 100 may include a three-way valve 702 for secure system isolation and that allows the addition of oil make-up. An output isolation check valve 740 prevents backflow during filter element maintenance. The oil filtration system 100 may also include a vent hose 722 for the venting of trapped air during startup or filter medium maintenance. In addition, the oil filtration system 100 may include a visible paddlewheel-style flow indicator 732 on the output that allows for quick inspection of oil quality and system operation.

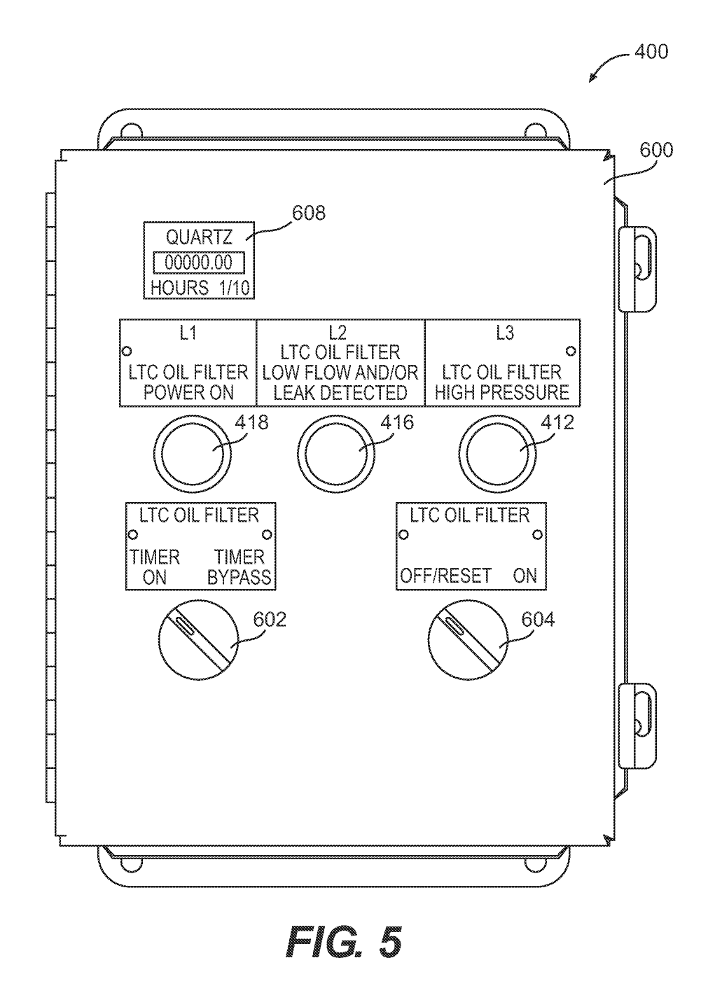

FIG. 5 illustrates a control box with bypass switch and motor runtime meter in accordance with a particular embodiment. For example, the control box 600 may include an enclosure with UL type 12 steel construction. When the bypass switch 602 and the associated bypass timer relay 444 is in the “Timer Bypass” mode, the oil filtration system 100 may operate with continuous operation without changing the programming of the pump on timer meter 438. The control box 600 may also include a runtime meter display 608 located on the front cover that indicates the total number of hours the pump motor 436 has operated in conjunction with the pump on timer meter 438. The control box 600 may include the high pressure alarm relay 420 that may be directly wired to a customer connection terminal block to monitor the high-pressure alarm LED indicator 412. The control box 600 may also include the low flow/leak detection relay 422 that may be directly wired to the customer connection terminal block to monitor the high pressure alarm 416. Further, the control box 600 may include the customer remote shutdown relay 424 that may be directly wired to the customer connection terminal block to shut-down the oil filtration system 100 in response to a customer-supplied signal. Additionally, the control box 600 may include indicator LED lights 412, 416, 418 as described above.

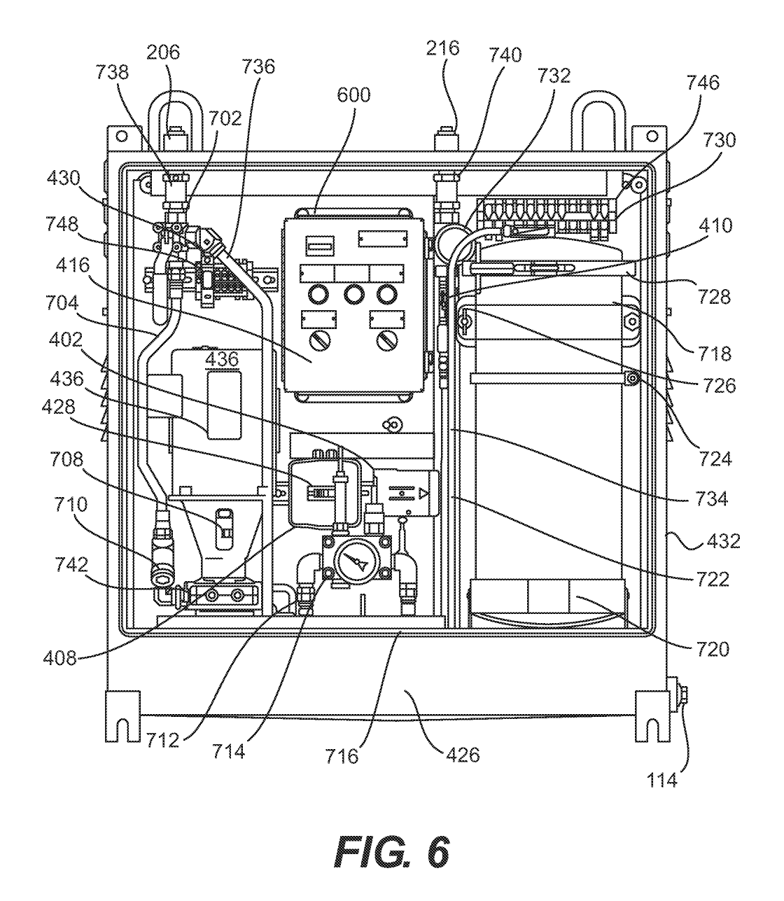

FIG. 6 illustrates various components of the control box in accordance with a particular embodiment of the invention. The oil filtration system may circulate insulating oil from the LTC oil tank 200 through the oil filtration system 100. The oil filtration system 100 may draw insulating oil from the LTC oil tank 200 at a rate of 1.0 GPM. The insulating oil may be pumped through a moisture absorbent filter element that absorbs water and removes particulates in the insulating oil. The oil filtration system 100 may be manually initiated by turning the system power switch 434 to the OFF position and back to ON position. Additionally, a bypass switch 602 manually operates the pump system without timer functions. Safety functions of the oil filtration system 100 may be in effect and may not be bypassed.

In an exemplary embodiment, the oil filtration system 100 may alarm when the pressure of the insulating oil reaches 85 PSIG or above and may signify that the filter change is needed. In another exemplary embodiment, the filter may be changed when the insulating oil pressure reaches 60-65 PSI or according to the recommendation of the filter cartridge manufacturer, whichever comes first. The lifespan of the filter cartridge depends on various factors, such as, for example, the number of LTC operations, pump size, filter size, pump timer settings and/or volume of insulating oil in the LTC tank, etc. The low flow switch may automatically shut-down the oil filtration system 100 when the insulating oil flow rate drops below 0.25 GPM. For additional safety, the integral pump pressure by-pass may automatically bypass the insulating oil when the insulating oil pressure exceeds 110 PSI.

Operation time of the oil filtration system 100 may be controlled by the timer/controller 414 located inside the control box 600. The timer/controller 414 can be accessed by removal of the front cover screws.

A high-pressure detection sensor 428 and a low flow/leak detection switch 410 located inside the control box 600 are used to monitor insulating oil pressure, flow rate and leaking conditions. The high-pressure detection sensor 428 and the low flow/leak detection switch 410 may introduce built-in time delays on both the high pressure alarms and low flow alarms in order to prevent false alarms during start-up stage of the oil filtration system 100. After the start-up stage, the oil filtration system 100 automatically shuts down in the event of high insulating oil pressure, low flow rate, and/or leaking conditions. In an exemplary embodiment, the high pressure alarms have a 5-minute delay that may provide time for the insulating oil to warm up and circulate through the filter during cold conditions in order to prevent false alarms. The oil filtration system 100 alarms the user of high insulating oil pressure, low flow rate and/or leaking conditions, for example. The low flow alarms may have a 15-second delay and will provide alarm if an insufficient volume of insulating oil is flowing through the oil filtration system 100. Various conditions may trigger the low flow alarms, such as, for example, motor fails to start, break occurs in insulating oil supply line, and insulating oil level falls below the anti-siphon hole.

The leak detection sensor 426 located in the cabinet sump 108 may immediately shut-down the oil filtration system 100 upon detecting fluid in the cabinet sump 108. For example, the leak detection sensor 426 may not be reset until the fluid has been removed from the cabinet sump 108. The oil filtration system 100 can be reset by turning the system power switch 434 to the OFF/RESET position and back to ON position. The alarms of the oil filtration system 100 may reset and the timer may also reset initiating operation of the pump 742 for the duration of the timer setting. Each of the alarm relays of the oil filtration system 100 may be wired to an Auxiliary Terminal Strip and can be wired into the customer's supervisory control and data acquisition (SCADA) system.

The oil filtration system 100 may operate differently under different conditions. For example, the oil filtration system 100 may operate in a continuous mode when the ambient temperature is below −6° C. (or 21° F.) based on system run cold sensor 432 to avoid excessive wear on the close tolerances of the pump 742 due to cold starts. The oil filtration system 100 may be automatically activated when the ambient temperature is below −6° C. (or 21° F.) based on the system run cold sensor 432 even when no scheduled run period is programmed. The automatic activation ensures that the oil filtration system 100 continues to provide clean insulating oil to the tank 202 protect the tank 200 during cold conditions. The automatic activation also ensures the problem of high pressure shut-downs during cold conditions. The oil filtration system 100 may revert back to normal programmed operation when the ambient temperature rises to 30° F. or higher based on the system run cold sensor 432.

In particular, FIG. 6 shows the details of the oil filtration system 100. The oil may be received in the oil input 206 as described above. The oil may flow through a check valve 738 and thereafter may flow through a three-way valve 702. Thereafter, the oil may exit the three-way valve 702 and flow through the hose 704. The three-way valve 702 may include a setting that allows oil flow through the valve 702, a setting that prevents oil from flowing through the valve 702, and a setting that allows oil to flow through a make-up hose 736. The make-up hose 736 allows a user to add oil to the oil filtration system 100. The oil may flow from the hose 704 and may enter a Y strainer 710. From the Y strainer 710, the oil may flow into the pump 742. The pump 742 may be driven by a pump motor 436. The pump motor 436 may be coupled to the pump 742 with a coupler 708.

Additionally, a sample port (not shown) may be arranged along the flow path between the oil input 206 and the Y strainer 710. This sample port may be configured to allow a sampling mechanism to obtain a sample of oil from the sample port. For example, a sampling mechanism, such as a syringe may be connected to the sample port and operated such that a sample of oil may be withdrawn from the sample port.

After exiting the pump 436, the oil may flow through a hose 712 and the pressure of the flow may be measured by a pressure gauge 714. After exiting the pressure gauge 714, the flow of oil may enter a hose 716 and may flow into a filter 718. In the filter 718 the oil may be filtered. After exiting the filter 718, oil may flow through the hose 734 and thereafter the oil may flow through visible paddlewheel-style flow indicator 732 that may include a window that allows a user to see the flow of oil therethrough. After the oil exits the visible paddlewheel-style flow indicator 732, the oil may pass through the output isolation check valve 740. Thereafter, the oil may exit the oil filtration system 100 through the oil output 216.

The filter 718 may be mounted on a tilt mechanism 720. The tilt mechanism 720 may allow a user to tilt the filter 718 for maintenance, repair, and cleaning. The filter 718 may further include a vent hose 722 to allow the filter 718 to vent as is necessary through a vent valve 730. To maintain the filter 718 within the cabinet 102, a restraint clamp 724 may be arranged to hold the filter 718 within the cabinet. Additionally the filter 718 may include a holding bracket 726 to help hold the assembly in place. The filter 718 may further include a lid, and the lid may be held in place by lid clamp 728.

Additionally the oil filtration system 100 may include a wiring terminal strip 746 and a wiring terminal block 748 to provide various hardwired connections to the components of the oil filtration system 100.

Accordingly, the invention provides a technique and apparatus for providing and improved oil filtration system that may operate under extreme conditions.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. An oil filtration system for a load tap changer, comprising:
a filter configured to filter an oil;
a pump fluidly coupled to an oil tank and configured to pump the oil from the oil tank through the filter and to return the oil to the oil tank; and
a control system, electrically coupled to the pump, to monitor ambient air temperature and control an operation of the pump in accordance therewith.

2. The oil filtration system according to claim 1 further comprising at least one of a high-pressure sensor, a flow sensor, a leak sensor, and a low flow sensor.

3. The oil filtration system according to claim 1 further comprising a heater configured to reduce condensation within at least part of the oil filtration system.

4. The oil filtration system according to claim 1 wherein the control system is further configured to monitor at least one of a high-pressure sensor, a flow sensor, a leak sensor, and a low flow sensor and control the operation of the pump in accordance therewith.

5. The oil filtration system according to claim 1 further comprising a high-pressure sensor, a flow sensor, a leak sensor, and a low flow sensor.

6. The oil filtration system according to claim 1 wherein the control system is further configured to monitor a high-pressure sensor, a flow sensor, a leak sensor, and a low flow sensor and control the operation of the pump in accordance therewith.

7. The oil filtration system according to claim 1 further comprising a timer configured to track a total time the pump is operated.

8. The oil filtration system according to claim 1 further comprising at least one indicator light to indicate a status of at least one of a high-pressure sensor, a flow sensor, a leak sensor, and a low flow sensor.

9. An oil filtration system for a load tap changer, comprising:
a filter configured to filter an oil;
a pump fluidly coupled to an oil tank and configured to pump the oil from the oil tank through the filter and to return the oil to the oil tank;
at least one of a high-pressure sensor, a flow sensor, a leak sensor, and a low flow sensor; and
a control system, electrically coupled to the pump, to monitor at least one of the high-pressure sensor, the flow sensor, the leak sensor, and the low flow sensor and control an operation of the pump in accordance therewith.

10. The oil filtration system according to claim 9 further comprising the high-pressure sensor, the flow sensor, the leak sensor, and the low flow sensor.

11. The oil filtration system according to claim 9 wherein the control system is further configured to monitor the high-pressure sensor, the flow sensor, the leak sensor, and the low flow sensor and control the operation of the pump in accordance therewith.

12. The oil filtration system according to claim 9 further comprising a heater configured to reduce condensation within at least part of the oil filtration system.

13. The oil filtration system according to claim 9 further comprising a timer configured to track a total time the pump is operated.

14. The oil filtration system according to claim 9 further comprising at least one indicator lights to indicate a status of at least one of the high-pressure sensor, the flow sensor, the leak sensor, and the low flow sensor.

15. An oil filtration process for a load tap changer, comprising:
arranging a filter to filter oil;
pumping oil from an oil tank through the filter and returning the oil to the oil tank;
sensing at least one of a high-pressure, a flow, a leak, and low flow; and
controlling the pumping in response to sensing at least one of the high-pressure, the flow, the leak, and the low flow.

16. The oil filtration process according to claim 15 wherein sensing at least one of the high-pressure, the flow, the leak, and the low flow comprises sensing with at least one of a high-pressure sensor, a flow sensor, and a leak sensor, and a low flow sensor.

17. The oil filtration process according to claim 15 further comprising heating to reduce condensation.

18. The oil filtration process according to claim 15 further comprising tracking an amount of total time of the process of pumping.

19. The oil filtration process according to claim 15 further comprising indicating with at least one indicator light a status of at least one of a high-pressure sensor, a flow sensor, a leak sensor, and a low flow sensor.
